(19) United States
(12) Patent Application Publication
(10) Pub. No.: US 2015/0331143 A1
(43) Pub. Date: Nov. 19, 2015

(54) METHOD OF RECOGNIZING SLOPE CONDITION, SYSTEM USING THE SAME, AND RECORDING MEDIUM FOR PERFORMING THE SAME

(71) Applicant: Foundation of Soongsil University-lndustry Cooperation, Seoul (KR)

(72) Inventors: Youngjoon HAN, Seoul (KR); Hwanik CHUNG, Seoul (KR); Sanghun HAN, Seoul (KR)

(21) Appl. No.: 14/542,648

(22) Filed: Nov. 16, 2014

(30) Foreign Application Priority Data
May 14, 2014 (KR) 10-2014-0057706

(51) Int. Cl. G01V 8/10; G06F 17/50

(52) U.S. Cl. CPC G01V 8/10; G06F 17/50

(57) ABSTRACT

A method for recognizing a slope condition is provided. The method includes obtaining an image of a slope and setting a region of interest thereof, calculating an initial slope model information of the region of interest and an optical flow information of the region of interest, first determining a first possibility of a slope failure based on the optical flow information, and when a degree of the first possibility is determined that the slope failure can occur, second determining a second possibility of the slope failure by a comparison between the initial slope model information and a slope information, wherein the slope information is obtained based on the optical flow information by scanning on a portion of the region of interest that the slope failure can occur

### CROSS-REFERENCE TO RELATED APPLICATION

This application claims priority to and the benefit of Korean Patent Application No. 10-2014-0057706, filed on May 14, 2014, the disclosure of which is incorporated herein by reference in its entirety.

### BACKGROUND

The present invention relates to a method of recognizing a slope condition capable of monitoring a condition of a slope in real time, a system using the same, and a recording medium for performing the same.

In general, a phenomenon in which a slope collapses is known as a landslide or a slope failure and includes falls, topples, slides, flows, spreads, and the like. Korea is a highly mountainous region. When roads, houses, and the like are constructed, slopes are cut out of mountains, hills, and the like. Slopes are also formed when dams, banks, and the like are built.

As described above, when the slope occurs, determination of stability of the slope is very important. A possibility of a landslide (a slope failure) needs to be predicted and responses thereto need to be devised in advance. The causes of the landslide may include inner factors such as geological qualities, soil qualities, geological feature structures, and geological vulnerabilities, natural external factors such as rain, snow melting, groundwater, erosion of rivers and coasts, and earthquakes, and artificial external factors such as cutting the ground, landfills, and dam building. When a shearing stress increases or a shearing strength decreases due to the above-described factors and a safety factor (=shearing strength/shearing stress) becomes 1, the landslide occurs. In Korea, landslides mainly occur during a period of heavy rain in the summer and during periods of thawing, which causes massive damage to life and property. However, in the slope in general, a single slope has different geological properties according to a depth, a degree of weathering, a degree of degradation, a presence and a type of a geological feature structure, and the like. Therefore, it is very difficult to accurately predict stability of the slope.

Therefore, recently, instruments capable of quantitatively determining behaviors of the slope have been used in order to evaluate stability of the slope. However, as current slope measuring methods, a system configured to detect and predict a displacement of a main occurrence place through an image sensor such as a general CCD camera is exemplified, but it is difficult to perform robust detection and prediction in real time when external environments are complex or ambient environments are changed. Also, it is difficult to perform prevention and prediction due to insufficient road safety systems in Korea. Therefore, the development of natural disaster warning systems is necessary.

### SUMMARY

The present invention provides a method of recognizing a slope condition in which a possibility of slope failure is primarily determined according to optical flow information, precise scan is performed on a partial region of a slope having a high possibility of failure, and a possibility of slope failure may be secondarily determined, a system using the same, and a recording medium for performing the same.

According to an aspect of the present invention, there is provided a method of recognizing a slope condition. The method includes obtaining an image of a slope and setting a region of interest, calculating initial slope model information and optical flow information of the region of interest, performing primary determination of a possibility of slope failure according to the optical flow information, and performing secondary determination of a possibility of slope failure such that, when it is determined in the primary determination that there is a possibility of slope failure, slope information is obtained by performing precise scan on a region having a high possibility of slope failure among the region of interest according to the optical flow information, and the initial slope model information and the slope information are compared.

The obtaining of an image of a slope and setting of a region of interest may include manually setting the region of interest by a user or automatically setting a preset region as the region of interest, and when the region of interest is set, a corresponding region may be divided into a plurality of blocks, and the initial slope model information and the optical flow information may be calculated.

In the calculating of the initial slope model information, information on the slope may be calculated as 3D geometric information by reflecting each piece of information of a plurality of blocks within the region of interest.

In the performing of the primary determination of a possibility of slope failure according to the optical flow information, an optical flow vector of a unit feature vector and a direction vector in a slope direction within the region of interest may be calculated, a first determination value may be calculated by an inner product of the optical flow vector and the direction vector in the slope direction, and when the first determination value is greater than a predetermined threshold value, it may be determined that there is a possibility of slope failure.

In the secondary determination of a possibility of slope failure by comparing the initial slope model information with slope information obtained by performing the precise scan, the number of changed corner feature points may be calculated by comparing distance information obtained by performing partial scan on candidate blocks having a high possibility of slope failure within the region of interest with the initial slope model information, and the possibility of slope failure may be secondarily determined by a ratio of the number of blocks included in the initial slope model information and the number of blocks whose distance information is changed.

According to another aspect of the present invention, there is provided a computer-readable recording medium. The medium may be a computer-readable recording medium recording a computer program for executing the method of recognizing a slope condition according to any of the above-described aspects.

According to still another aspect of the present invention, there is provided a system for recognizing a slope condition. The system includes a camera configured to capture a slope and obtain an image, a laser instrument configured to measure distance information of the image and measure depth information of the slope, a region of interest setting unit configured to set a region of interest of the image, an initial model generating unit configured to obtain initial slope model information of the region of interest, an optical flow calculating unit configured to calculate optical flow information of the region of interest, a first determining unit configured to determine a possibility of failure of the slope using the optical flow information, and a second determining unit configured to, when it is primarily determined that there is a possibility of failure of the slope, perform precise scan on a partial region having a relatively large optical flow vector within the region of interest, and determine a possibility of failure of the slope by comparing slope information that is generated by the precise scan with the initial slope model information.

The region of interest setting unit may divide the region of interest into a plurality of blocks, and the initial model generating unit may calculate information on the slope as 3D geometric information by reflecting distance information of the plurality of blocks.

The first determining unit may calculate an optical flow vector of a unit feature vector and a direction vector in a slope direction within the region of interest, calculate a first determination value by an inner product of the optical flow vector and the direction vector in a slope direction, and determine that there is a possibility of slope failure when the first determination value is greater than a predetermined threshold value.

The second determining unit may calculate the number of changed corner feature points by comparing distance information obtained by performing partial scan on a candidate region having a high possibility of slope failure within the region of interest with the initial slope model information, and secondarily determine a possibility of slope failure by a ratio of the number of blocks included in the initial slope model information and the number of blocks whose distance information is changed.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a system for recognizing a slope condition according to an embodiment of the present invention;

FIG. 2 is a control block diagram of the system for recognizing a slope condition according to the embodiment of the present invention;

FIGS. 3a and 3b show setting of a region of interest and obtained initial slope model information in the system for recognizing a slope condition according to the embodiment of the present invention;

FIGS. 4a and 4b are diagrams illustrating the results of computation of an optical flow from a corner feature in the system for recognizing a slope condition according to the embodiment of the present invention;

FIGS. 5a and 5b are diagrams illustrating detection of optical flow information using the Lucas-Kanade method in the system for recognizing a slope condition according to the embodiment of the present invention;

FIGS. 6a and 6b are diagrams illustrating optical flow occurrence blocks when the system for recognizing a slope condition according to the embodiment of the present invention performs secondary determination and a result of a partial scan on a region thereof;

FIG. 7 is a diagram illustrating a triangle string method used for outputting a stereoscopic image in the system for recognizing a slope condition according to the embodiment of the present invention;

FIG. 8 is a diagram illustrating a configuration of rendering an image texture in the system for recognizing a slope condition according to the embodiment of the present invention;

FIG. 9 is a diagram illustrating computation of a displacement volume of a place in which a displacement occurs in order to compute an exact amount of displacement in the system for recognizing a slope condition according to the embodiment of the present invention;

FIGS. 10a and 10b are diagrams illustrating the result of a precise scan on a block in which an optical flow occurs and computation of an amount of displacement using the result;

FIG. 11 is a diagram illustrating a method of calculating a volume of the block that has been precisely scanned due to occurrence of the optical flow; and

FIGS. 12 and 13 are control flowcharts illustrating a method of recognizing a slope condition according to an embodiment of the present invention.

### DETAILED DESCRIPTION

Detailed descriptions of the invention will be made with reference to the accompanying drawings illustrating specific embodiments of the invention as examples. These embodiments will be described in detail such that the invention can be performed by those skilled in the art. It should be understood that various embodiments of the invention are different but are not necessarily mutually exclusive. For example, a specific shape, structure, and characteristic of an embodiment described herein may be implemented in another embodiment without departing from the scope and spirit of the invention. In addition, it should be understood that a position or an arrangement of each component in each disclosed embodiment may be changed without departing from the scope and spirit of the invention. Accordingly, there is no intent to limit the invention to the detailed descriptions to be described below. The scope of the invention is defined by the appended claims and encompasses all equivalents that fall within the scope of the appended claims. Like numbers refer to the same or like functions throughout the description of the figures.

Hereinafter, exemplary embodiments of the present invention will be described in greater detail with reference to the drawings.

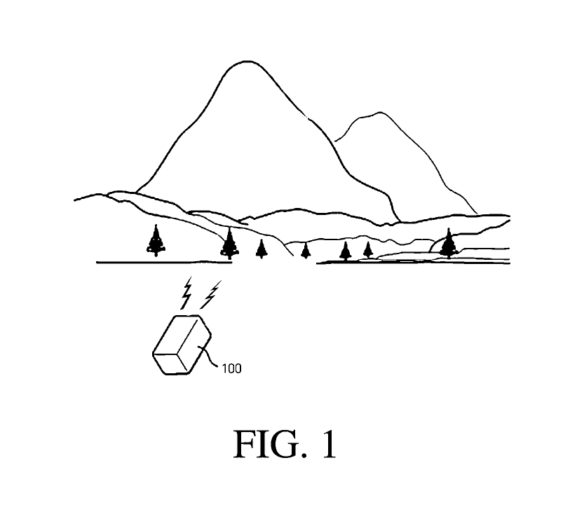

FIG. 1 is a diagram illustrating a system for recognizing a slope condition according to an embodiment of the present invention.

A system for recognizing a slope condition 100 may predict a slope failure by recognizing a condition of a slope. The system for recognizing a slope condition 100 may set a region of interest of the slope, obtain 3D information by scanning a corresponding region, and extract initial slope model information. The region of interest may be arbitrarily set by a user. Information on a desired place may be obtained by designating a size and a location of the region of interest, and the number of scan points.

The system for recognizing a slope condition 100 may obtain initial slope model information through image information input from a camera and distance information recognized by a laser instrument.

The system for recognizing a slope condition 100 may compute optical flow information in order to perform primary determination of a possibility of slope failure. Several methods such as the known Lucas-Kanade method, Black-Jepson method, Horn-Schunck method, and the like may be used to compute the optical flow information. A method of computing the optical flow using the Lucas-Kanade method is described in detail in “Title of the paper: An Iterative Image Registration Technique with an Application to Stereo Vision, author: Bruce D. Lucas Takeo Kanade.” The Black-Jepson method is described in detail in “Title of the paper: Estimating Optical Flow in Segmented Images Using Variable-Order Parametric Models With Local Deformations, author: Michael J. Black, Member, IEEE, and Allan D. Jepson.” The Horn-Schunck method is described in detail in “Title of the paper: Determining Optical Flow, author: Berthold K. P Horn and Brian G. Schunck.” Hereinafter, computation of the optical flow using the Lucas-Kanade method will be exemplified. However, needless to say, the embodiment of the present invention is not limited to computation of the optical flow information using the Lucas-Kanade method.

The system for recognizing a slope condition 100 may perform primary determination of a possibility of slope failure in consideration of a size and a direction of an optical flow vector included in the optical flow information. When it is primarily determined that there is a possibility of slope failure, the system for recognizing a slope condition 100 may perform a secondary determining operation by performing a precise scan on a block of an initial slope model having a large optical flow vector using the laser instrument.

When it is measured in the primary determining operation that an amount of occurrence of an optical flow in a slope direction is equal to or greater than a threshold value in consecutive image frames, the system for recognizing a slope condition 100 may determine that the slope has a high possibility of failure. In order to determine a possibility of slope failure more accurately, the system for recognizing a slope condition 100 performs a precise scanning operation on a region having a high possibility of slope failure using the laser instrument, and may perform secondary determination of a possibility of failure within the region of interest by comparing the result with the initial slope model.

The system for recognizing a slope condition 100 may realistically output a 3D stereoscopic image of a region that is determined to have a high possibility of slope failure through the above-described primary determining operation and secondary determining operation. In order to realistically represent a stereoscopic image, the system for recognizing a slope condition 100 may perform rendering a texture of a real image using each scan point as a starting point.

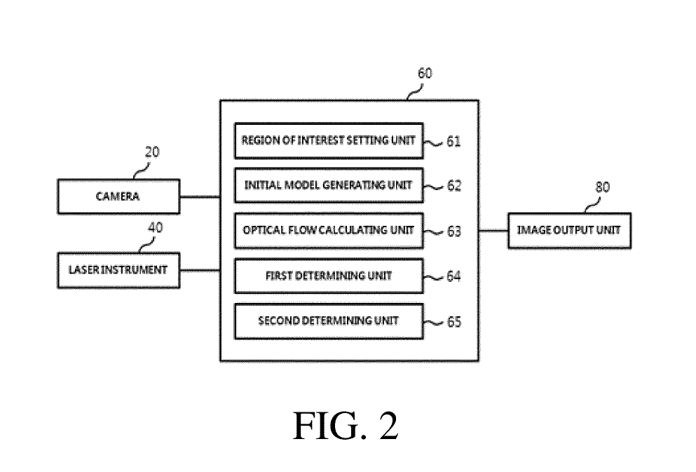

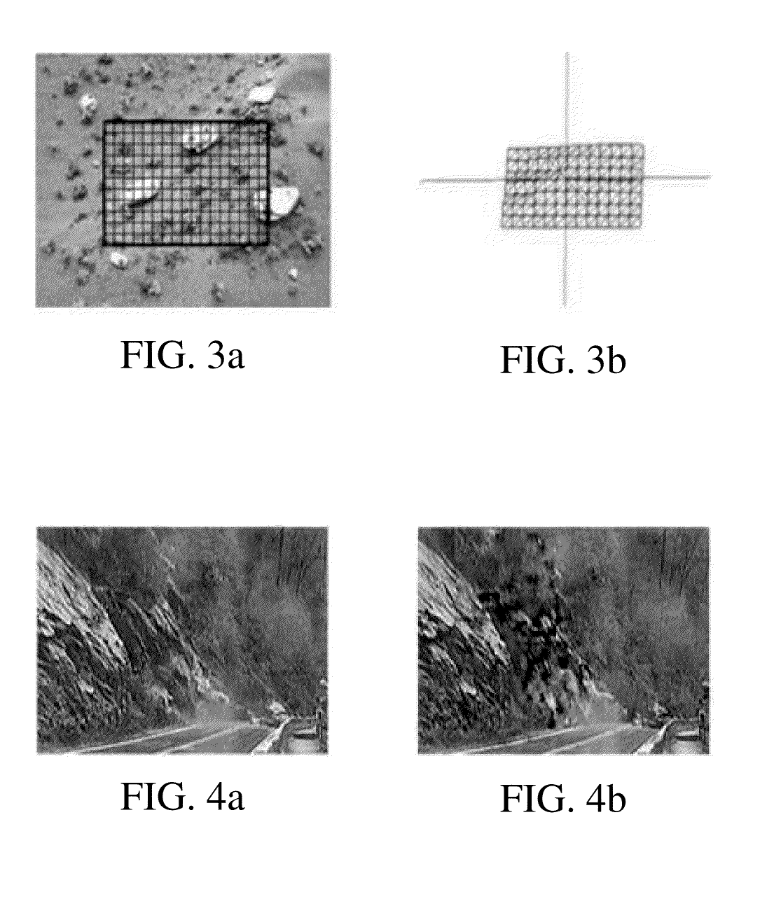

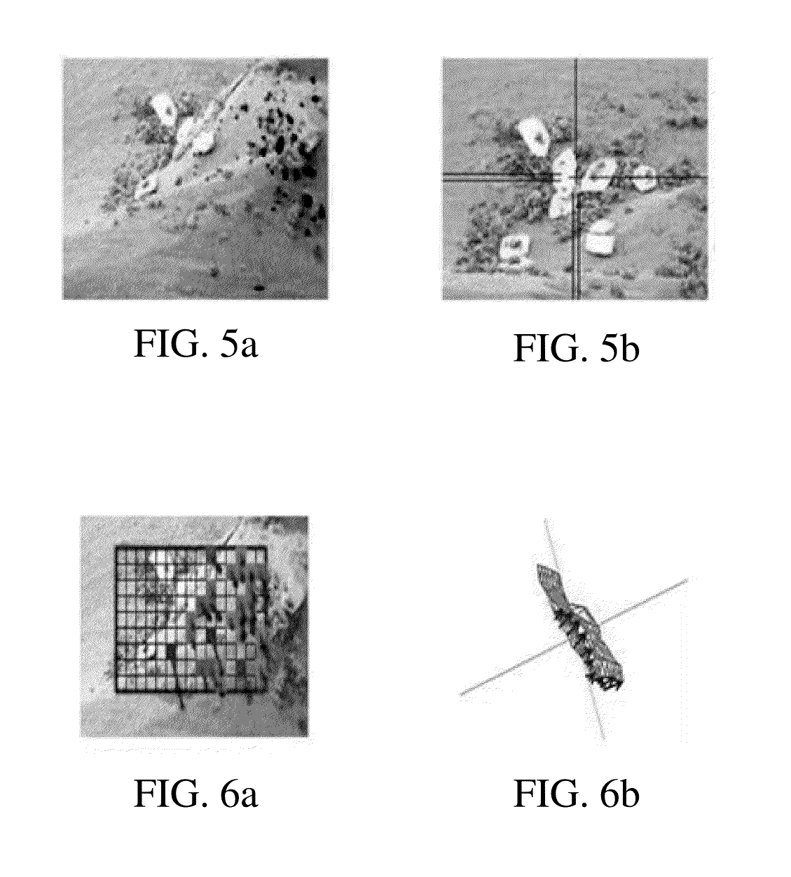

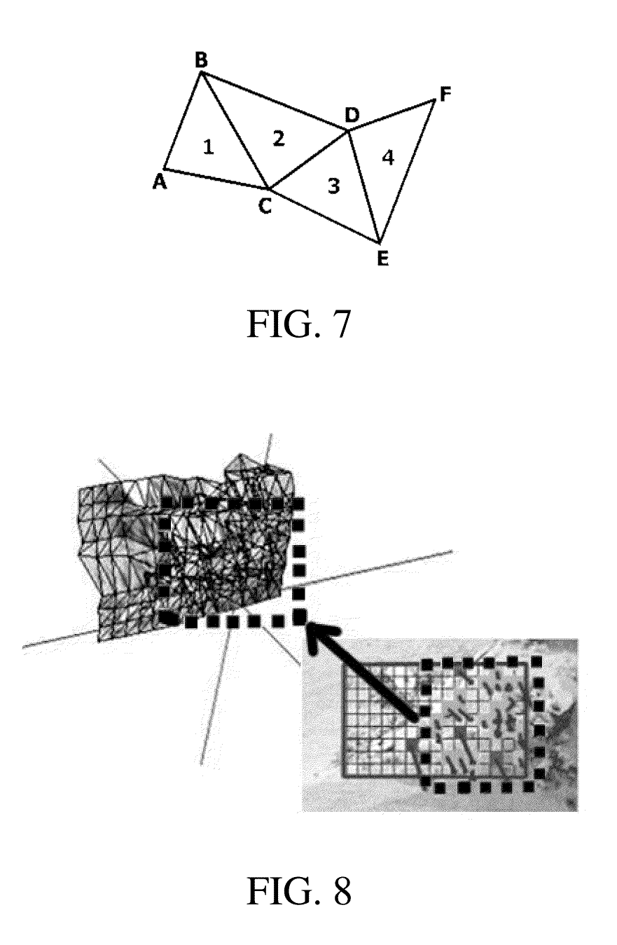

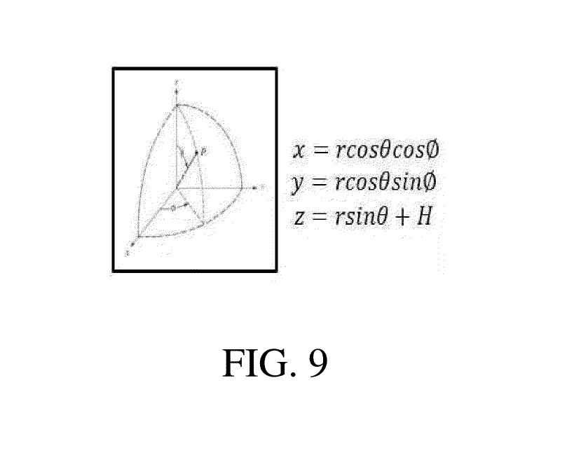

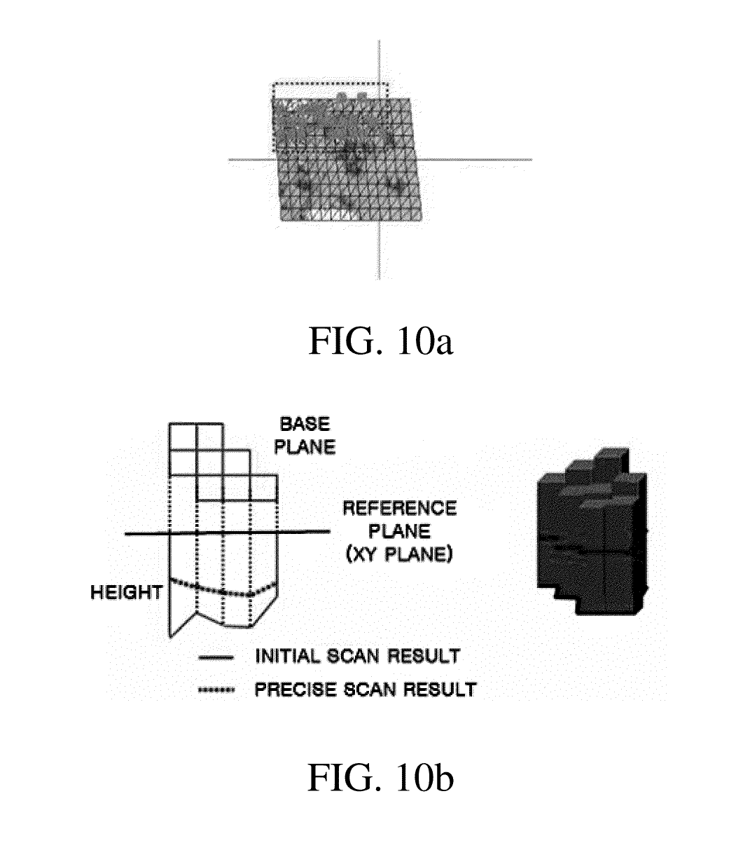

FIG. 2 is a control block diagram of the system for recognizing a slope condition according to the embodiment of the present invention. FIGS. 3a and 3b show setting of a region of interest and obtained initial slope model information in the system for recognizing a slope condition according to the embodiment of the present invention. FIGS. 4a and 4b are diagrams illustrating the results of computation of an optical flow from a corner feature in the system for recognizing a slope condition according to the embodiment of the present invention. FIGS. 5a and 5b are diagrams illustrating detection of optical flow information using the Lucas-Kanade method in the system for recognizing a slope condition according to the embodiment of the present invention. FIGS. 6a and 6b are diagrams illustrating optical flow occurrence blocks when the system for recognizing a slope condition according to the embodiment of the present invention performs secondary determination and a result of a partial scan on a region thereof. FIG. 7 is a diagram illustrating a triangle string method used for outputting a stereoscopic image in the system for recognizing a slope condition according to the embodiment of the present invention. FIG. 8 is a diagram illustrating a configuration of rendering an image texture in the system for recognizing a slope condition according to the embodiment of the present invention. FIG. 9 is a diagram illustrating computation of a displacement volume of a place in which a displacement occurs in order to compute an exact amount of displacement in the system for recognizing a slope condition according to the embodiment of the present invention. FIGS. 10a and 10b are diagrams illustrating the result of a precise scan on a block in which an optical flow occurs and computation of an amount of displacement using the result.

The system for recognizing a slope condition 100 may include a camera 20 configured to capture a slope and obtain an image, a laser instrument 40 configured to measure depth information of the slope, a slope failure determination unit 60 configured to determine a possibility of slope failure, and an image output unit 80 configured to output a stereoscopic image of a corresponding region when it is determined that there is a possibility of slope failure.

The slope failure determination unit 60 may include a region of interest setting unit 61 configured to set a region of interest of the obtained image, an initial model generating unit 62 configured to obtain initial slope model information of a corresponding region when the region of interest is set, an optical flow calculating unit 63 configured to calculate an optical flow of the region of interest, a first determining unit 64 configured to determine a possibility of slope failure using the calculated optical flow, and a second determining unit 65 configured to determine a possibility of slope failure by performing precise scan on a corresponding region when it is primarily determined that there is a possibility of slope failure.

The camera 20 may capture a slope according to the user's manipulation and obtain an image. Among the image captured by the camera 20, a part of the region may be set as a region of interest. The region of interest is a region that is set to check whether there is a possibility of slope failure, and may be arbitrarily set by the user.

The laser instrument 40 may scan the region that is set as the region of interest among the region captured by the camera 20 and obtain 3D geometric information of the slope. The initial slope model may be formed through distance information of a scan point obtained by precisely scanning a slope whose conditions are to be recognized. The initial slope model may be used as a determination reference when secondary determination of a possibility of slope failure to be described is performed.

The region of interest setting unit 61 may set the region of interest in the image captured by the camera 20. The region of interest may be passively set by the user or a predetermined region set in advance may be automatically set as the region of interest.

When the region of interest is set in the image, the region of interest setting unit 61 may divide a corresponding region into N blocks

When distance information of the slope of the region of interest is measured by the laser instrument 40, the initial model generating unit 62 may calculate the initial slope model using corresponding information. The initial slope model may be derived as 3D geometric information by reflecting each piece of distance information of a plurality of blocks within the region of interest. As illustrated in FIG. 3, the region of interest is set in the image of the captured slope, and the initial slope model may be generated by performing a laser scan on the set region of interest.

The optical flow calculating unit 63 may calculate optical flow information of the region of interest. As described above, the optical flow information may be computed using several methods such as the known Lucas-Kanade method, Black-Jepson method, Horn-Schunck method, and the like. Here, a method of computing the optical flow information using the Lucas-Kanade method will be exemplified.

In the Lucas-Kanade method, the optical flow may be computed using a corner feature of which a value is found in perpendicular directions by performing spatial differentiation in X axis and Y axis directions of the image. FIG. 4 shows the results of optical flow vectors calculated using the Lucas-Kanade algorithm in a slope landslide image.

The optical flow vector may be computed from brightness improvement, time persistence, and space consistency. In general, a value of a pixel in a specific object is not significantly changed when an image frame is changed. That is, it is assumed that brightness of a corner pixel to be tracked in an input gray image in order to compute an optical flow of corner feature points is not changed. This assumption is valid since an amount of change of an object between consecutive image frames is not large when a time is more rapidly changed than a movement of the object in the image. Also, points adjacent to each other in a space are highly likely to be included in the same object and may have the same movement.

According to the above-described assumption, the same two points of the same object in consecutive image frames may be represented as Equation 1. When the right hand side of Equation 1 is expanded as Taylor series, Equation 2 may be calculated. In order to simultaneously satisfy Equation 1 and Equation 2, a sum of the differential equation of Equation 2 should be 0. By dividing the differential equation by dt, an optical flow constraint equation, Equation 3, may be calculated.

$$\begin{matrix} I ( x , y , t ) = I ( x + d x , y + d y , t + d t ) & Equation 1 \\ I ( x + d x , y + d y , t + d t ) = I ( x , y , t ) + \frac{\partial I}{\partial x} d x + \frac{\partial I}{\partial y} d y + \frac{\partial I}{\partial t} d t + … & Equation 2 \\ {I}_{x} {V}_{x} + {I}_{y} {V}_{y} = - {I}_{t} & Equation 3\end{matrix}$$

When a spatial differential value can be computed in an X axis direction and a Y axis direction of the image from Equation 3, it is possible to predict the optical flow that is a movement vector of the object in image coordinates.

In the Lucas-Kanade algorithm, a window Ω having a predetermined size is set based on corner feature points of a t-th image frame and then a location of an image that is the most similar to the set window is found in a (t+1)-th image frame.

Iₓ(q₁)Vₓ+I_{y}(q₁)V_{y}=−Iₜ(q₁)

Iₓ(q₂)Vₓ+I_{y}(q₂)V_{y}=−Iₜ(q₂)

. . .

Iₓ(qₘ)Vₓ+I_{y}(qₘ)V_{y}=−Iₜ(qₘ) Equation 4

Here, q₁, q₂, and qₘ are pixels included in the window Ω. That is, q₁, q₂, . . . , qₘεΩ.

An optical flow constraint equation in the window Ω set in the t-th image frame may be represented as Equation 4, and may be represented as Equation 5 when it is expressed in the form of a determinant Ax=b.

$$[ \begin{matrix}{I}_{x} ( {q}_{1} ) & {I}_{y} ( {q}_{1} ) \\ {I}_{x} ( {q}_{2} ) & {I}_{y} ( {q}_{2} ) \\ ⋮ & ⋮ \\ {I}_{x} ( {q}_{m} ) & {I}_{y} ( {q}_{m} )\end{matrix} ] [ \begin{matrix}{V}_{x} \\ {V}_{y}\end{matrix} ] = [ \begin{matrix}- {I}_{t} ( {q}_{1} ) \\ - {I}_{t} ( {q}_{2} ) \\ ⋮ \\ - {I}_{t} ( {q}_{m} )\end{matrix} ] \qquad Equation 5$$

When an expression of an optical flow vector V is summarized from Equation 5, Equation 6 may be calculated. When a least mean square is applied to (A^{T}A) of Equation 6, Equation 7 may be obtained. A movement vector of the set window in the t-th image frame may be calculated from Equation 7.

$$\begin{matrix}v = [ \begin{matrix}{V}_{x} \\ {V}_{y}\end{matrix} ] = {( {A}^{T} A )}^{- 1} {A}^{T} b & Equation 6 \\ [ \begin{matrix}{V}_{x} \\ {V}_{y}\end{matrix} ] = {[ \begin{matrix}{\sum }_{{q}_{i} ∈ Ω} {{I}_{x} ( {q}_{i} )}^{2} & {\sum }_{{q}_{i} ∈ Ω} {I}_{x} ( {q}_{i} ) {I}_{y} ( {q}_{i} ) \\ {\sum }_{{q}_{i} ∈ Ω} {I}_{y} ( {q}_{i} ) {I}_{x} ( {q}_{i} ) & {\sum }_{{q}_{i} ∈ Ω} {{I}_{y} ( {q}_{i} )}^{2}\end{matrix} ]}^{- 1} [ \begin{matrix}- {Σ}_{{q}_{i} ∈ Ω} {I}_{x} ( {q}_{i} ) {I}_{t} ( {q}_{i} ) \\ - {Σ}_{{q}_{i} ∈ Ω} {I}_{y} ( {q}_{i} ) {I}_{t} ( {q}_{i} )\end{matrix} ] & Equation 7\end{matrix}$$

In the Lucas-Kanade algorithm according to the embodiment of the present invention, an image pyramid is formed from an original image, tracking is performed from an upper layer to a lower layer, and a feature point having a large movement may be found in a short time.

In order for the laser instrument to efficiently scan, a unit feature vector Xᵣ formed of corner feature points Xᵣₖ(Xₖ,Yₖ) within N blocks of the initial slope model may be represented as Equation 8.

Xᵣ=[Xᵣ₁Xᵣ₂ . . . X_{rN}]^{t} Equation 8

Vᵣ=[Vᵣ₁Vᵣ₂ . . . V_{rN}]^{t} Equation 9

An optical flow of each corner feature forming a unit feature vector is predicted using the Lucas-Kanade algorithm, and an optical flow vector V, of the unit feature vector may be represented as Equation 9.

FIG. 5 shows the results obtained by applying the Lucas-Kanade algorithm to unit feature vectors of the region of interest. FIG. 5 shows that a displacement with a large or small change can be detected robustly.

The first determining unit 64 refers to the initial slope model formed of N blocks, and may calculate a vector V_{g} formed of unit vectors in a slope gradient direction in each corner feature vector as Equation 10.

V_{g}=[V_{g1}V_{g2} . . . V_{gN}]^{t} Equation 10

Here, V_{gk}(Vₓ,V_{y}) denotes a unit vector in a slope gradient direction in corner feature points Xᵣₖ of a k-th block.

That is, |V_{gk}(Vₓ,V_{y})|=(Vₓ²+Vₓ²)^{0.5}=1 is established.

The first determining unit 64 may perform primary determination for efficient scanning of the laser instrument by calculating an optical flow vector (Vᵣ) of a unit feature vector (Xₖ) and a direction vector (V_{g}) in a slope direction.

The first determining unit 64 may primarily determine whether there is a slope failure in consideration of a size and a direction of the optical flow vector. The first determining unit 64 calculates a first determination value that is obtained by an inner product of the optical flow vector (Vᵣ) and the slope direction vector (V_{g}). A primary discriminant is the same as in Equation 11.

$$\begin{matrix}{D}_{1} ( {V}_{r} , {V}_{g} ) = {V}_{r} \cdot {V}_{g} \\ = {\sum }_{k = 0}^{N} ( {V}_{rk} \cdot {V}_{gk} ) \\ = {\sum }_{k = 0}^{N} ( \vert {V}_{rk} \vert cos {θ}_{r} )\end{matrix} \qquad Equation 11$$

Here, θᵣ denotes an angle formed by an optical flow vector (Vᵣ) in a corner feature vector (Xᵣₖ) and a direction vector (V_{gk}) in a slope direction. When the first determination value is greater than a predefined threshold value T1, it is determined that there is a possibility of slope failure.

When it is primarily determined through the above operation that there is a possibility of failure of the slope including the region of interest, the second determining unit 65 performs precise scan on a block of the initial slope model having a large optical flow vector using the laser instrument 40 with reference to the unit feature vector and the optical flow vector.

When the first determination value is greater than the threshold value, the second determining unit 65 performs a precise scanning operation on a block having a high possibility of slope failure by controlling the laser instrument 40 in order to secondarily determine a possibility of slope failure, and may perform secondary determination based on 3D information obtained by the precise scanning operation.

In the secondary determination, precise scan on blocks including corner features having high occurrence of the optical flow is performed, the result is compared with the initial slope model, and it is possible to verify whether there is a slope failure using a displacement in the region of interest

FIG. 6 shows a block in which the optical flow occurs in the region of interest and a direction of the optical flow. As illustrated in FIG. 6, the block in which the optical flow occurs is shown in green, and may be shown in a darker color when more optical flow occurs. Also, since partial scan is performed on only the corresponding block in which the optical flow occurs, it is possible to decrease a scan time of the laser instrument 40 and quickly determine an emergency situation such as a slope failure.

The second determining unit 65 compares distance information obtained by partial scan on candidate blocks having a high possibility of slope failure by the first determining unit 64 with the initial slope model, and computes the number of changed corner feature points N_{c}. As shown in Equation 12, secondary determination may be determined as a ratio of the number of blocks in the region of interest (N) of the initial slope model and the number of blocks whose distance information is changed (N_{c}).

$${D}_{2} ( N , {N}_{c} ) = \frac{{N}_{c}}{N} \qquad Equation 12$$

When a second determination value is greater than a predefined threshold value T2, the second determining unit 65 may determine that a landslide or an emergency situation has occurred.

When it is determined through the above operation that there is a high possibility of slope failure, the image output unit 80 may perform a rendering operation to generate a texture of a real image using each scan point of the region of interest as a starting point in order to realistically express a 3D stereoscopic image.

The image output unit 80 may represent each scan point first on a stereoscopic coordinate system using a triangle string method for rendering. As illustrated in FIG. 7, since the triangle string method forms a stereoscopic plane with a plurality of triangles, it is inefficient to draw each triangle separately. In the triangle string method, a triangle is drawn using three vertices, and then objects may be expressed by adding vertices.

The image output unit 80 may perform rendering of the initial slope model and depth information obtained by partial scan using an image texture. FIG. 8 illustrates an example.

When all condition recognitions are completed, the image output unit 80 may compute a displacement volume of a place in which a displacement occurs in order to compute an exact amount of displacement. The displacement volume may be measured by precisely scanning a block in which the optical flow occurs in the primary determination. A measurement value of the laser instrument may be obtained as distance and angle information of a spherical coordinate system.

The image output unit 80 may register measurement information to a corresponding point of the image using correction technology of the camera 20. The image output unit 80 computes an amount of displacement based on real measurement information. The image output unit 80 may convert each piece of angle and distance information into x, y, and z of a 3D Cartesian coordinate system in FIG. 9 with respect to the laser instrument 40.

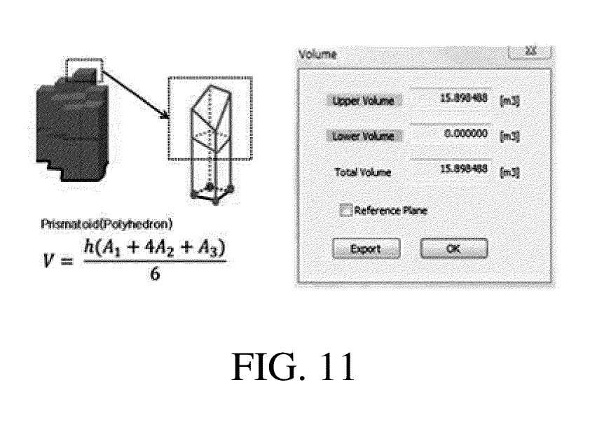

The image output unit 80 may measure a volume through a difference between the initial slope model and the precise scan result based on an XY plane of the Cartesian coordinate system. FIG. 10A shows the result of precise scan on a block in which the optical flow occurs. FIG. 10B shows computation of an amount of displacement according to the initial scan result and the precise scan result. A real block may be divided into a square pillar and a prismatoid as illustrated in FIG. 11. A volume of the block that has been precisely scanned due to occurrence of the optical flow is a sum of volumes of the prismatoid and the prismatoid as illustrated in FIG. 11.

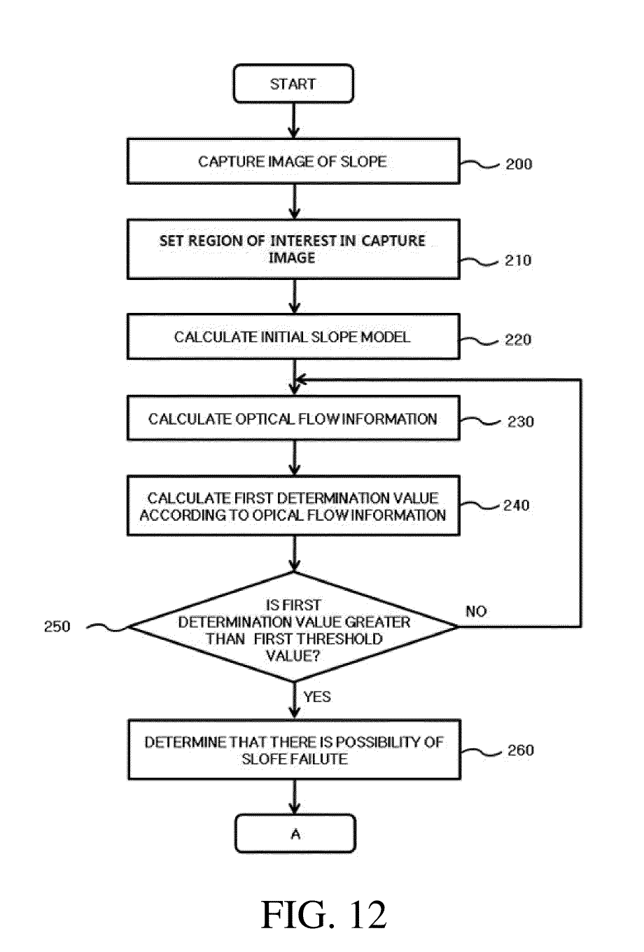

FIG. 12 is a control flowchart illustrating a system for recognizing a slope condition according to an embodiment of the present invention.

The camera 20 captures and obtains an image of a slope. Among the slope obtained by the camera 20, a part of the region may be set as a region of interest according to the user's manipulation or a predetermined rule (200 and 210).

When distance information of the slope of the region of interest is measured by the laser instrument 40, the initial model generating unit 62 may calculate the initial slope model using corresponding information. The initial slope model may be derived as 3D geometric information by reflecting each piece of distance information of a plurality of blocks within the region of interest (220).

The optical flow calculating unit 63 may calculate optical flow information of the region of interest. The optical flow information may be calculated by the known plurality of methods (230).

The first determining unit 64 may perform primary determination of a possibility of slope failure according to the optical flow information calculated by the optical flow calculating unit 63. The first determining unit 64 may perform primary determination for efficient scanning of the laser instrument by calculating an optical flow vector (V_r) of a unit feature vector (X_k) and a direction vector (V_g) in a slope direction. The first determining unit 64 calculates a first determination value that is obtained by an inner product of the optical flow vector (V_r) and the slope direction vector (V_g). When the first determination value is greater than a predefined threshold value T1, it is determined that there is a possibility of slope failure (240, 250, and 260).

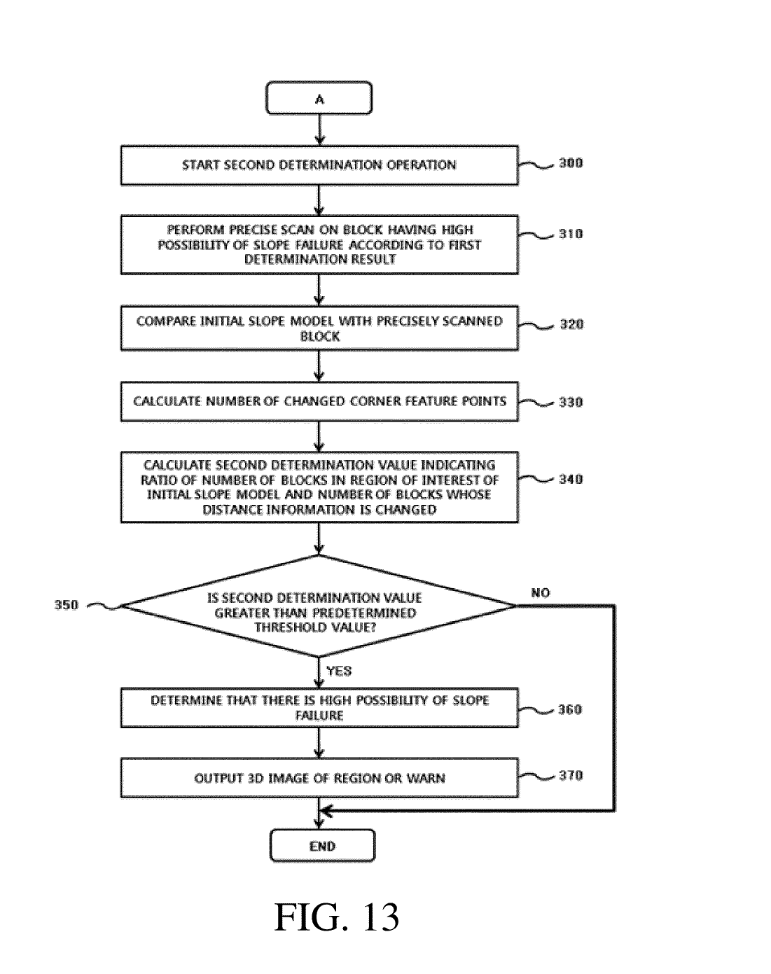

FIG. 13 is a control flowchart illustrating a method of recognizing a slope condition according to an embodiment of the present invention.

When the first determination value is greater than the threshold value, the second determining unit 65 performs a precise scanning operation on a block having a high possibility of slope failure by controlling the laser instrument 40 in order to secondarily determine a possibility of slope failure, and may perform secondary determination based on 3D information obtained by the precise scanning operation (300 and 310).

The second determining unit 65 performs precise scan on blocks including corner features having high occurrence of the optical flow, compares the result with the initial slope model, and may verify whether there is a slope failure using a displacement in the region of interest (320).

The second determining unit 65 compares distance information obtained by partial scan on candidate blocks having a high possibility of slope failure by the first determining unit 64 with the initial slope model, and computes the number of changed corner feature points N_{c}. Secondary determination may be determined as a ratio of the number of blocks in the region of interest (N) of the initial slope model and the number of blocks whose distance information is changed (N_{c}), and the ratio serves as a second determination value (330 and 340).

The second determining unit 65 compares the second determination value with a size of the predetermined threshold value, and secondarily determines that there is a high possibility of slope failure when the second determination value is greater than the predetermined threshold value (350 and 360).

When it is determined through the above operation that there is a high possibility of slope failure, the image output unit 80 may perform a rendering operation to generate a texture of a real image using each scan point of the region of interest as a starting point in order to realistically express a 3D stereoscopic image. The image output unit 80 performs the above operation, outputs a 3D screen, and enables the user to easily observe a place having a high possibility of slope failure in a stereoscopic manner (370).

In this manner, technology for determining a possibility of slope failure by capturing a slope may be implemented in an application or a form of program instructions that may be executed through various computer components, and may be recorded in computer readable recording media. The computer readable recording media may include a program instruction, a data file, a data structure, and the like, or combinations thereof.

The program instruction recorded in the computer readable recording media may be specially designed and prepared for the invention or may be an available well-known instruction for those skilled in the field of computer software.

Examples of the computer readable recording media include, for example, magnetic media such as a hard disk, a floppy disk, and a magnetic tape, optical media such as a CD-ROM and a DVD, magneto-optical media such as a floptical disk, and a hardware device, such as a ROM, a RAM, and a flash memory, that is specially configured to store and perform the program instruction.

Examples of the program instruction may include a machine code generated by a compiler and a high-level language code that can be executed in a computer using an interpreter. Such a hardware device may be configured as at least one software module in order to perform operations of the invention and vice versa.

According to the embodiment of the present invention, since a possibility of slope failure is primarily determined according to optical flow information and a possibility of slope failure is secondarily determined by performing partial scan on only a region having a high displacement among the region of interest, it is possible to determine a possibility of slope failure more rapidly and accurately.

While the present invention has been described above with reference to the embodiments, it may be understood by those skilled in the art that various modifications and alternations may be may be made without departing from the spirit and scope of the present invention described in the appended claims.

While the present invention have been described above with reference to the embodiments, it may be understood by those skilled in the art that various modifications and alternations may be may be made without departing from the spirit and scope of the present invention described in the appended claims.

What is claimed is:

1. A method for recognizing a slope condition, the method comprising:
obtaining an image of a slope and setting a region of interest thereof;
calculating an initial slope model information of the region of interest and an optical flow information of the region of interest;
first determining a first possibility of a slope failure based on the optical flow information; and
when a degree of the first possibility is determined that the slope failure can occur, second determining a second possibility of the slope failure by a comparison between the initial slope model information and a slope information, wherein the slope information is obtained based on the optical flow information by scanning on a portion of the region of interest that the slope failure can occur.

2. The method according to claim 1,
wherein the obtaining and the setting further comprise manually setting the region of interest by a user or automatically setting a preset region as the region of interest, and
wherein, when the region of interest is set, dividing the region of interest into a plurality of blocks, and calculating the initial slope model information and the optical flow information.

3. The method according to claim 2, wherein the calculating comprises calculating three-dimensional (3D) geometric information of the slope based on each distance information of the plurality of the blocks in the region of interest.

4. The method according to claim 1, wherein, the first determining comprises calculating an optical flow vector of a unit feature vector and a direction vector in a slope direction in the region of interest,
calculating a first determination value by a dot product of the optical flow vector and the direction vector in the slope direction, and
when the first determination value is greater than a predetermined threshold value, determining that the slope failure can occur.

5. The method according to claim 1, wherein the second determining further comprises:
calculating a number of changed corner feature points by a comparison between the initial slope model information and distance information, wherein the distance information is obtained by scanning a portion of candidate blocks in the region of interest that the slope failure can occur, and
determining the second possibility of the slope failure by considering a ratio of a number of first blocks and a number of second blocks, wherein the first blocks are included in the initial slope model information, and the second blocks are blocks that the distance information has been changed.

6. A computer-readable recording medium recording a computer program for executing the method for recognizing a slope condition, the method comprising:
obtaining an image of a slope and setting a region of interest thereof;
calculating an initial slope model information of the region of interest and an optical flow information of the region of interest;
first determining a first possibility of a slope failure based on the optical flow information; and
when a degree of the first possibility is determined that the slope failure can occur, second determining a second possibility of the slope failure by a comparison between the initial slope model information and a slope information, wherein the slope information is obtained based on the optical flow information by scanning on a portion of the region of interest that the slope failure can occur.

7. The computer-readable recording medium recording a computer program for executing the method for recognizing a slope condition according to claim 6, wherein the obtaining and the setting further comprise manually setting the region of interest by a user or automatically setting a preset region as the region of interest, and
wherein, when the region of interest is set, dividing the region of interest into a plurality of blocks, and calculating the initial slope model information and the optical flow information.

8. The computer-readable recording medium recording a computer program for executing the method for recognizing a slope condition according to claim 6, wherein the calculating comprises calculating three-dimensional (3D) geometric information of the slope based on each distance information of the plurality of the blocks in the region of interest.

9. The computer-readable recording medium recording a computer program for executing the method for recognizing a slope condition according to claim 6, wherein, the first determining comprises calculating an optical flow vector of a unit feature vector and a direction vector in a slope direction in the region of interest,
calculating a first determination value by a dot product of the optical flow vector and the direction vector in the slope direction, and
when the first determination value is greater than a predetermined threshold value, determining that the slope failure can occur.

10. The computer-readable recording medium recording a computer program for executing the method for recognizing a slope condition according to claim 6, wherein the second determining further comprises:
calculating a number of changed corner feature points by a comparison between the initial slope model information and distance information, wherein the distance information is obtained by scanning a portion of candidate blocks in the region of interest that the slope failure can occur, and
determining the second possibility of the slope failure by considering a ratio of a number of first blocks and a number of second blocks, wherein the first blocks are included in the initial slope model information, and the second blocks are blocks that the distance information has been changed.

11. A system for recognizing a slope condition, the system comprising:
a camera configured to capture and to obtain an image of a slope;
a laser instrument configured to measure distance information from the image and calculate depth information of the slope;
a region of interest setting unit configured to set a region of interest in the image;
an initial model generating unit configured to obtain an initial slope model information of the region of interest;
an optical flow calculating unit configured to calculate an optical flow information of the region of interest;
a first determination unit configured to determine a first possibility of a slope failure using the optical flow information; and
when a degree of the first possibility is determined that the slope failure can occur, a second determination unit configured to scan a portion of the region of interest having a relatively large optical flow vector, and to determine a second possibility of the slope failure by a comparison between the initial slope model information and a slope information obtained by scanning on the portion of the region of interest.

12. The system according to claim 11, wherein the region of interest setting unit is configured to divide the region of interest into a plurality of blocks, and
wherein the initial model generating unit is configured to calculate three-dimensional (3D) geometric information of the slope based on distance information of the plurality of the blocks in the region of interest.

13. The system according to claim 11, wherein the first determination unit is configured to calculate an optical flow vector of a unit feature vector and a direction vector in a slope direction in the region of interest,
to calculate a first determination value by a dot product of the optical flow vector and the direction vector in a slope direction, and
when the first determination value is greater than a predetermined threshold value, to determine that the slope failure can occur,
calculating a number of changed corner feature points by a comparison between the initial slope model information and distance information, wherein the distance information is obtained by scanning a portion of candidate blocks in the region of interest that the slope failure can occur, and
determining the second possibility of the slope failure by considering a ratio of a number of first blocks and a number of second blocks, wherein the first blocks are included in the initial slope model information, and the second blocks are blocks that the distance information has been changed.

14. The system according to claim 11, wherein the second determination unit is configured to calculates a number of changed corner feature points by comparison between the initial slope model information and distance information, wherein the distance information is obtained by scanning a portion of candidate region in the region of interest that the slope failure can occur, and
the second determination unit is configured to determine the second possibility of the slope failure by considering a ratio of a number of first blocks and a number of second blocks, wherein the first blocks are included in the initial slope model information, and the second blocks are blocks that the distance information has been changed.
